(19) United States
(12) Patent Application Publication
(10) Pub. No.: US 2005/0201733 A1
(43) Pub. Date: Sep. 15, 2005

(54) Method for fast synchronization of video and audio playback

(76) Inventors: Shao-Nung Chiu, Taipei (TW); Feng-Sheng Yang, Taipei (TW); Chi-Hong Yang, Taipei (TW)

Correspondence Address: BIRCH STEWART KOLASCH & BIRCH, PO BOX 747, FALLS CHURCH, VA, 22040-0747, US

(21) Appl. No.: 10/922,853

(22) Filed: Aug. 23, 2004

(30) Foreign Application Priority Data
Mar. 12, 2004 (TW) 093106772

(51) Int. Cl. H04N 5/76; H04N 9/475

(52) U.S. Cl. 386/96; 348/515

(57) ABSTRACT

A method for fast synchronization of video and audio playback determines whether or not a video/audio signal is synchronous; determines whether or not a previous video/audio adjustment value of said video/audio signal is adjusted; determines whether said previous video/audio adjustment value is greater than a first determination value; comparing whether said previous video/audio adjustment value is greater than a second determination value; adds a first video/audio adjustment counter value and a first video/audio adjustment value; and stores said adjusted first video/audio adjustment value as a video/audio adjustment value for the next time. By using the method for fast synchronization of video and audio playback of the invention, video and audio playback of a digital versatile disk in a DVD player are always synchronous in all circumstances.

### BACKGROUND OF THE INVENTION

1. Field of the Invention

The present invention relates to a method for fast synchronization of video and audio playback and particularly to an adjustment method for fast synchronizing video and audio signals read from a digital versatile disk in a DVD player.

2. Description of the Related Art

Since the age of family digitization is coming, many manufacturers have made large investments in the research and development of family electric appliances in order to hold a position in this field. The family digitization mostly takes place in the field of family electric appliances. For the development of family video/audio products, technologies are improving and many manufacturers who made traditional video recorders are now transferring to VCD and DVD player manufacturing.

Current DVD players are provided with the functions of traditional video recorders and VCD players. Additionally, new functions, such as Dolby Digital effect, multi-format support (e.g., DVD, VCD, CD, CD-R, SVCD and MP3), multi-language support, image browser (e.g., JPEG file viewer) and built-in video/audio synchronization, are added thereinto.

When a DVD is reproduced by a DVD player, video and audio signals are asynchronous. At this time, the built-in video/audio synchronization function in the DVD player will be activated to synchronize video and audio playback.

A system counter (SCR Counter), which always counts up, is provided in the DVD player, and the value generated by the system counter serves as a standard reference for the playback of both video and audio signals. In addition, the audio portion recorded during the manufacture of the DVD includes an audio playback timing value (APTS), which is employed to control the audio playback time. Therefore, the system counter value and the audio playback timing value, i.e., video and audio playback signals, are compared with each other to achieve video/audio synchronization.

Reference is made to FIG. 1, which illustrates a flowchart of a conventional method for video and audio synchronization according to the prior art. First, whether video and audio signals are synchronous is determined in step S100. In this synchronization examination process, a predetermined frequency is employed by the video/audio system. Received signals are examined by the system and categorized into two major types, i.e., those with video greater than audio and those with audio greater than video. If video is greater than audio, then whether a video/audio adjustment value is greater than a determination value is determined in step S102, in which the determination value may be variously defined in a software depending on the vendors. If the examination result shows that the video/audio adjustment value is smaller than the determination value, then the examination process terminates (S110).

If the examination result shows that the video/audio adjustment value is greater than the determination value, then the system reduces the video playback speed to match up with the audio playback by changing a forward speed of the video counter in step S104. Then, in step S106, whether the video/audio adjustment value is smaller than a tolerance value is examined. If the determination result is negative, then the examination process terminates (S110). If the determination result is positive, then a normal video playback speed is set in step S108 and finally the examination process terminates (S110).

If audio is determined to be greater than video in the step of examining whether the video and audio signals are synchronous, the system proceeds to step S112, where whether the video/audio adjustment value is greater than the determination value is examined. If the examination result shows that the video/audio adjustment value is smaller than the determination value, then the examination process terminates (S110). If the examination result shows that the video/audio adjustment value is greater than the determination value, then the video playback speed is increased by the system in step S114 and whether the video/audio adjustment value is smaller than the tolerance value is further examined in step S116. If the video/audio adjustment value is determined to be greater than the tolerance value, then the examination process terminates (S110). If the video/audio adjustment value is determined to be smaller than the tolerance value, then a normal video playback speed is set in step S108 and finally the examination process terminates (S110).

Although the above described prior art provides the function of video/audio synchronization, this mechanism is designed for fine tuning of slight differences between video and audio signals and therefore the determination value and the video counter value are both set with small differences. Once the data of the optical disk cannot be successfully read by the servo system, for example, when the optical disk suffers a strong shock or is forced to cease operating, the audio counter value recorded on the optical disk cannot be read into the system while the video counter value in the system keeps on counting up. In this case, the video counter value will suddenly become much greater than the audio counter value. This issue is treated as a general fine-tuning condition in a conventional synchronization mechanism. That is, the movement is slowed down with by small increment, resulting in a serious asynchronous problem for a long period of time. In practical applications, the movement on the screen will stop and stay at the same frame with the sounds keeping coming out until the video and audio signals become synchronized.

### SUMMARY OF THE INVENTION

The present invention provides a method for fast synchronization of video and audio playback, comprising the steps of: examining whether or not a video/audio signal is synchronous; examining whether or not a previous video/audio adjustment value of said video/audio signal is adjusted; comparing whether said previous video/audio adjustment value is greater than a first determination value; comparing whether said previous video/audio adjustment value is greater than a second determination value; adding a first video/audio adjustment counter value and a first video/audio adjustment value; and storing said adjusted first video/audio adjustment value as a video/audio adjustment value for the next time.

By using the method for fast synchronization of video and audio playback of the invention, video and audio playback of a digital versatile disk in a DVD player is always synchronous in all circumstances.

### BRIEF DESCRIPTION OF THE DRAWINGS

Features and advantages of the present invention will be fully understood from the detailed description to follow taken in conjunction with the examples as illustrated in the accompanying drawings, which are to be considered in all respects as illustrative and not restrictive, wherein:

FIG. 1 is a flowchart showing a conventional method for video and audio synchronization according to the prior art;

FIG. 2 is a flowchart showing a method for fast synchronization of video and audio playback according to the present invention;

FIG. 3 is a flowchart showing a method for examining a previous video/audio adjustment value in the fast synchronization of video and audio playback according to the present invention; and

FIGS. 4A and 4B illustrate a flowchart of the preferable example of the method for fast synchronization of video and audio playback according to the present invention.

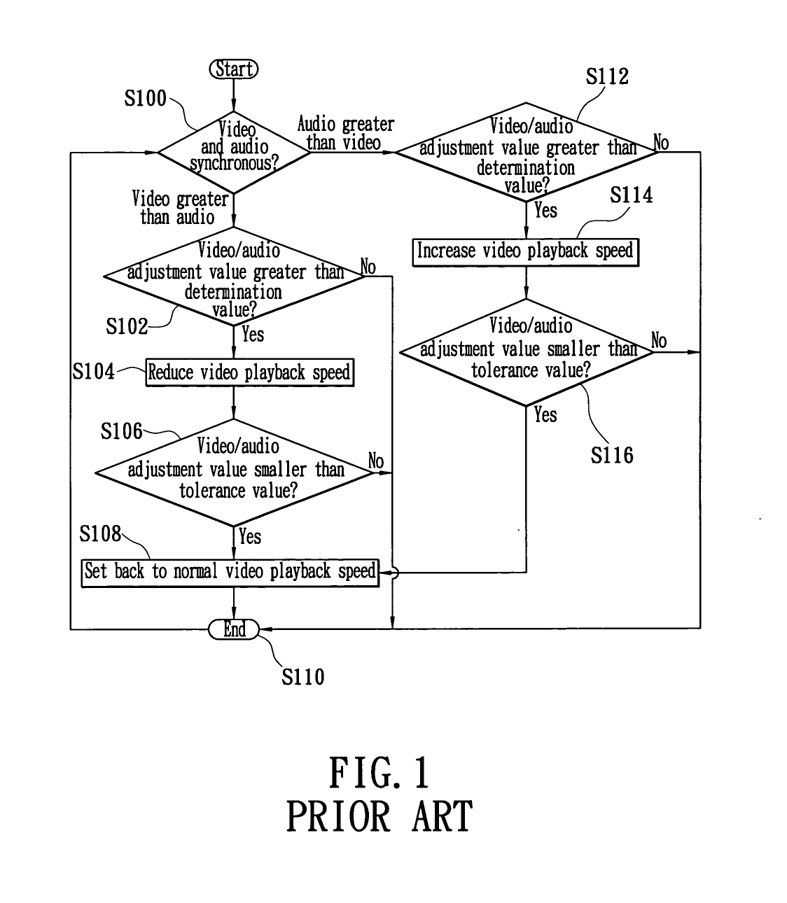

### DETAILED DESCRIPTION OF PREFERRED EMBODIMENTS

During the manufacture of a typical digital versatile disk, video and audio signals are respectively recorded in different tracks. When a digital versatile disk is reproduced by a DVD player, the video/audio synchronization mechanism is employed to synchronize video and audio playback of the digital versatile disk. In the following example, a method for synchronizing video and audio playback in the case where the video signal is greater than the audio signal is disclosed. However, a similar method can be used when the audio signal is greater than the video signal and therefore its description is hereby omitted for simplicity.

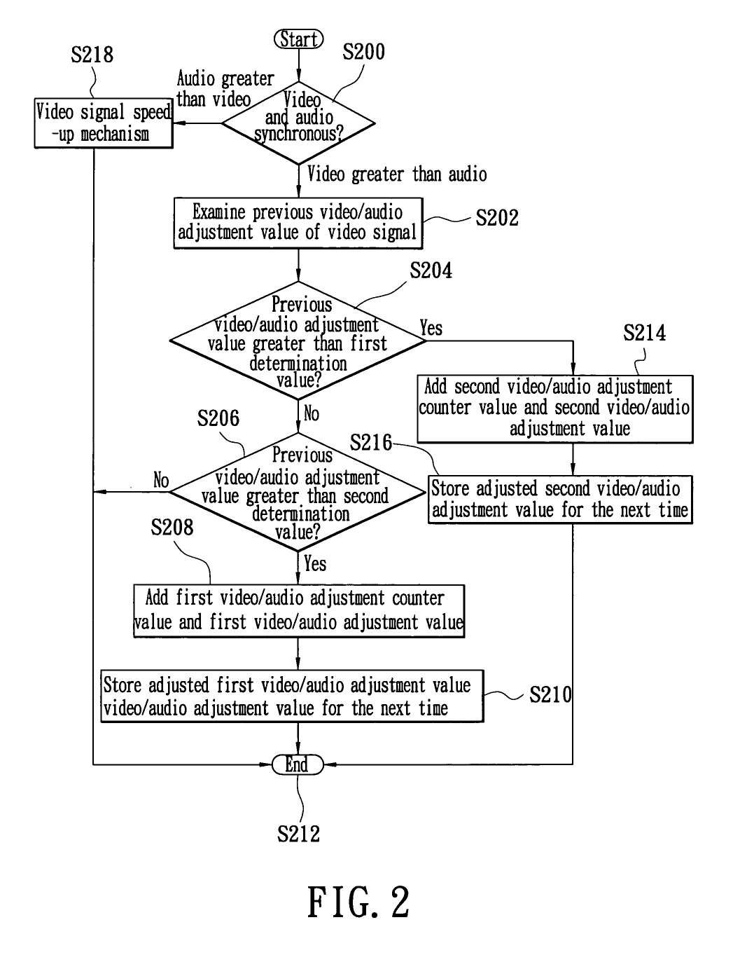

Reference is made to FIG. 2, which illustrates a flowchart showing a method for fast synchronization of video and audio playback according to the present invention. In the video/audio system, a synchronization examination process is carried out with a predetermined frequency. According to the method, whether or not a video/audio signal, which includes a video signal and an audio signal, is synchronous is examined in step S200. If the examination result shows that the video signal is smaller than the audio signal in the step of examining whether or not the video/audio signal is synchronous, then the video/audio system proceeds to a video signal speed-up mechanism in step S218. If the examination result shows that the video signal is greater than the audio signal, then a previous video/audio adjustment value of the video signal is further examined in step S202. A value of “1” obtained in the step of examining the previous video/audio adjustment value of the video signal indicates that the previous video/audio adjustment value is adjusted. A value of “0” indicates that the previous video/audio adjustment value is unadjusted. The previous video/audio adjustment value has three bits for three different aspects, in which the last bit is used to indicate whether the previous video/audio adjustment value is adjusted or unadjusted, the second bit is used to indicate whether a speed-up adjustment or a speed-down adjustment is performed, and the third bit is used to indicate whether the adjustment is performed slowly or fast.

If a value “0” is obtained or the previous video/audio adjustment value is unadjusted, the previous video/audio adjustment value is compared with a first determination value in step S204. The first determination value is an upper limit for the video/audio adjustment value and its value is 11. If the comparison result shows that the previous video/audio adjustment flag value is greater than the first determination value, then a second video/audio adjustment counter value and a second video/audio adjustment value are added in step S214 and the adjusted second video/audio adjustment value is stored in step S216 as the video/audio adjustment flag value for the next time. The second video/audio adjustment counter value is hexadecimal 0x232, while the second video/audio adjustment value is hexadecimal 0x0007. On the other hand, if the comparison result shows that the previous video/audio adjustment flag value is smaller than the first determination value, then whether the previous video/audio adjustment value is greater than a second determination value is examined in step S206. The second determination value is an upper limit for the video/audio adjustment value and its value is 7.

If the examination result shows that the previous video/audio adjustment value is smaller than the second determination value in the step of examining whether the previous video/audio adjustment value is greater than the second determination value, the previous video/audio adjustment value is within the tolerance value acceptable by the system and therefore the examination process terminates (S212). On the other hand, if the examination result shows that the previous video/audio adjustment value is greater than the second determination value, then a first video/audio adjustment counter value and a first video/audio adjustment value are added in step S208. The first video/audio adjustment counter value is hexadecimal 0x14a, while the first video/audio adjustment value is hexadecimal 0x0003. Further, the first video/audio adjustment value is stored in step S210 as the video/audio adjustment value for the next time. Then, the examination process terminates (S212). In the above process, each of the first video/audio adjustment value and the first video/audio adjustment counter value is obtained by dividing the system counter value with a value so as to control the forward speed of the movement on the screen. The movement becomes slow if the dividend is large, whereas the movement becomes fast if the dividend is small.

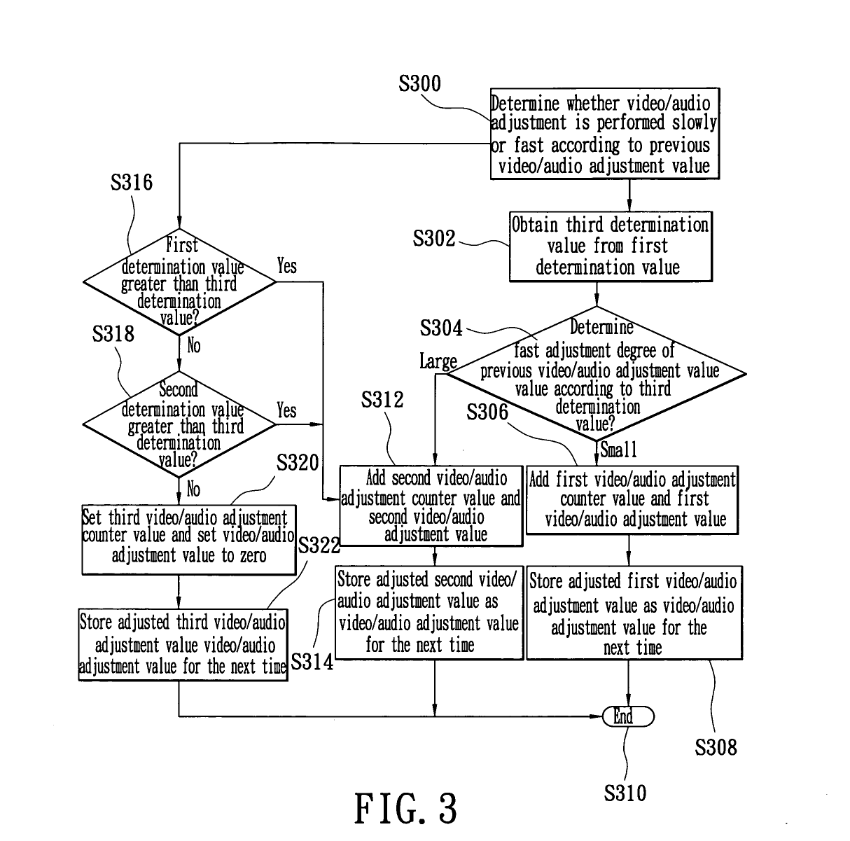

Reference is made to FIG. 3, which is a flowchart showing a method for examining a previous video/audio adjustment value in the fast synchronization of video and audio playback according to the present invention. This method includes a step S300 of determining whether the video/audio adjustment is performed slowly or fast according to the previous video/audio adjustment value. In this step, it is examined whether the third bit from the last in the previous video/audio adjustment value is 1. An examination result of 0 indicates that the adjustment is performed slowly. Further, in step S316, it is compared whether a first determination value is greater than the third determination value. The first determination value is an upper limit for the video/audio adjustment value and its value is 11. The third determination value is a lower limit for the video/audio adjustment value. If the comparison result is negative in the step of comparing whether the first determination value is greater than the third determination value, then the process continues to step S318, where whether a second determination value is greater than the third determination value is examined. The second determination value is 7 and it is an upper limit for the video/audio adjustment value. If the examination result is negative in the step of examining whether the second determination value is greater than the third determination value, then a third video/audio adjustment counter value is set and the video/audio adjustment value is set to zero in step S320. In addition, the adjusted third video/audio adjustment value is stored in step S322 as the video/audio adjustment value for the next time. The third video/audio adjustment counter value is hexadecimal 0x12a, which corresponds to the original video/audio synchronous speed.

If the comparison result is positive in the step of comparing whether the second determination value is greater than the third determination value, then a second video/audio adjustment counter value and a second video/audio adjustment value are added in step S312 and the adjusted second video/audio adjustment value is stored in step S314 as the video/audio adjustment value for the next time. The second video/audio adjustment counter value is hexadecimal 0x232, and the second video/audio adjustment value is hexadecimal 0x0007.

If the comparison result is positive in the step of comparing whether the first determination value is greater than the third determination value, then a second video/audio adjustment counter value and a second video/audio adjustment value are added in step S312 and the adjusted second video/audio adjustment value is stored in step S314 as the video/audio adjustment value for the next time. The second video/audio adjustment counter value is hexadecimal 0x232, and the second video/audio adjustment value is hexadecimal 0x0007.

If the examination result shows a fast adjustment in the step of determining whether the video/audio adjustment is performed slowly or fast according to the previous video/audio adjustment value, it indicates the optical disk is suffering a strong shock or is forced to cease operating and therefore a much greater video/audio adjustment value is obtained. In step S302, the system further obtains a third determination value from a first determination value. Subsequently, the fast adjustment degree of the previous video/audio adjustment value is determined in step S304 according to the third determination value. If the determination result is small in the step of determining the fast adjustment degree of the previous video/audio adjustment value according to the third determination value, then a first video/audio adjustment counter value and a first video/audio adjustment value are added in step S306 and the adjusted first video/audio adjustment value is stored in step S308 as the video/audio adjustment value for the next time. Then, the examination process terminates (S310). The first video/audio adjustment counter value is hexadecimal 0x14a, and the first video/audio adjustment value is hexadecimal 0x0003. On the other hand, if the determination result is large, then a second video/audio adjustment counter value and a second video/audio adjustment value are added in step S312 and the adjusted second video/audio adjustment value is stored in step S314 as the video/audio adjustment value for the next time. The second video/audio adjustment counter value is hexadecimal 0x232, and the second video/audio adjustment value is hexadecimal 0x0007.

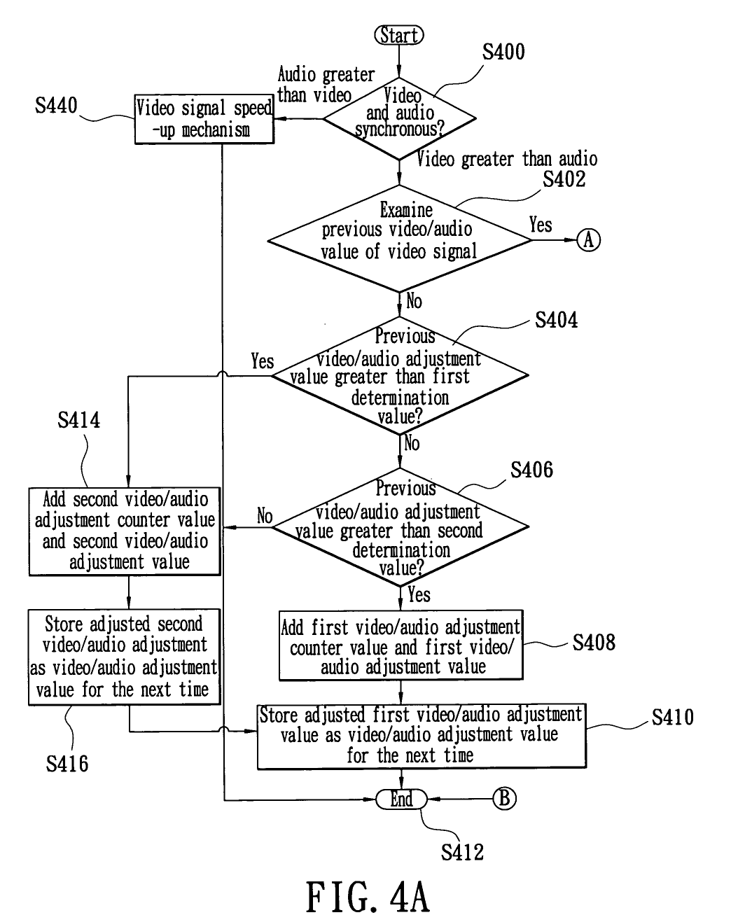

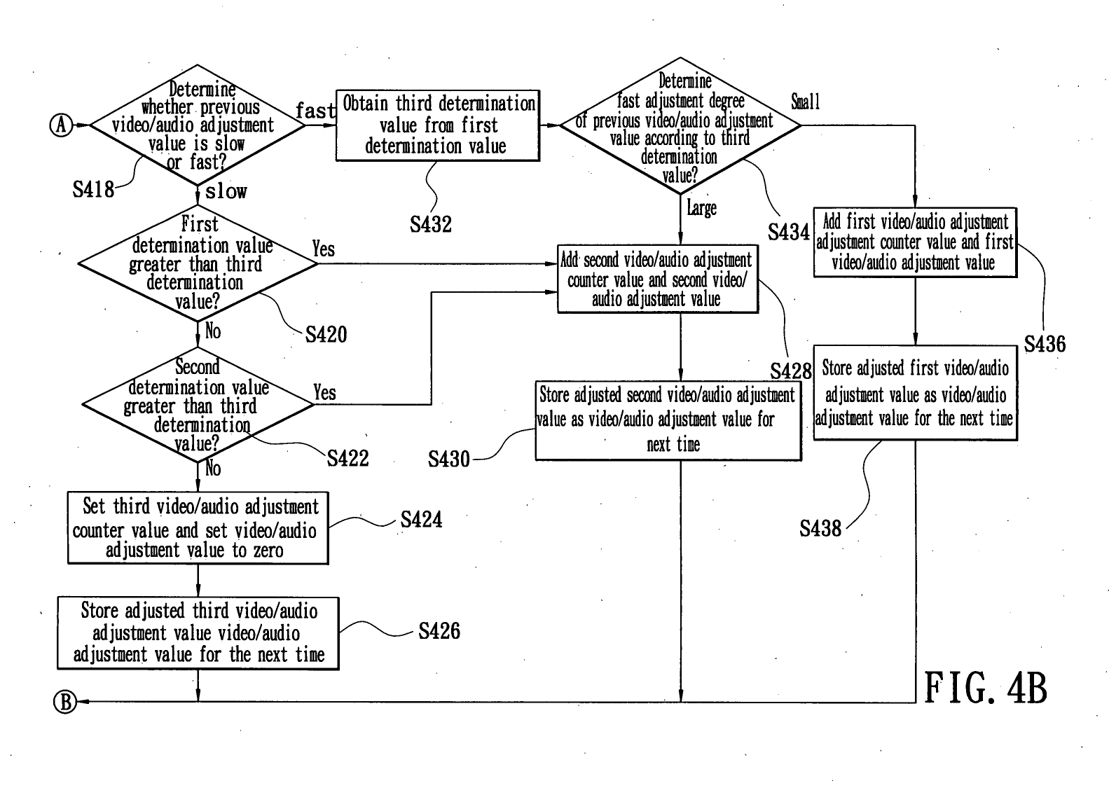

Reference is made to FIGS. 4A and 4B, which illustrate a flowchart of the preferable example of the method for fast synchronization of video and audio playback according to the present invention. In this synchronization examination process, a predetermined frequency is employed by the video/audio system. According to the method, it is first examined whether or not a video/audio signal, which includes a video signal and an audio signal, is synchronous in step S400. If the examination result shows that the video signal is smaller than the audio signal in the step of examining whether or not a video/audio signal is synchronous, then the process continues to a video signal speed-up mechanism in step S440. If the examination result shows that the video signal is greater than the audio signal, then whether or not a previous video/audio adjustment value of the video/audio signal is adjusted is examined in step S402. A value of “1” indicates that the previous video/audio adjustment value is adjusted. A value of “0” indicates that the previous video/audio adjustment value is unadjusted. The previous video/audio adjustment value has three bits for three different aspects, in which the last bit is used to indicate whether the previous video/audio adjustment value is adjusted or unadjusted, the second bit is used to indicate whether a speed-up adjustment or a speed-down adjustment is performed, and the third bit is used to indicate whether the adjustment is performed slowly or fast. If the examination result is negative in the step of examining the previous video/audio adjustment value of the video/audio signal, then whether the previous video/audio adjustment value is greater than a first determination value is examined in step S404.

If the examination result is negative in the step of determining whether the previous video/audio adjustment value is greater than a first determination value, whether the previous video/audio adjustment value is greater than a second determination value is examined in step S406. If the examination result is negative in the step of examining whether the previous video/audio adjustment value is greater than a second determination value, then the examination process terminates (S412). On the other hand, if the examination result is negative, then a first video/audio adjustment counter value and a first video/audio adjustment value are added in step S408 and the adjusted first video/audio adjustment value is stored in step S410 as the video/audio adjustment value for the next time. The first video/audio adjustment counter value is hexadecimal 0x14a, and the first video/audio adjustment value is hexadecimal 0x0003. In the above process, each of the first video/audio adjustment value and the first video/audio adjustment counter value is obtained by dividing the system counter value with a value so as to control the forward speed of the movement on the screen. The movement becomes slow if the dividend is large, whereas the movement becomes fast if the dividend is small.

If the comparison result is positive in the step of comparing whether the previous video/audio adjustment value is greater than a first determination value, then a second video/audio adjustment counter value and a second video/audio adjustment value in step S414 and the adjusted second video/audio adjustment value are stored in step S416 as the video/audio adjustment value for the next time. The second video/audio adjustment counter value is hexadecimal 0x232, and the second video/audio adjustment value is hexadecimal 0x0007. If the examination result is positive in the step of examining a previous video/audio adjustment value of the video/audio signal, then whether the adjustment of the previous video/audio adjustment value is performed fast or slowly is examined in step S418. In this step, it is examined whether the third bit from the last in the previous video/audio adjustment value is 1. In this step, it is examined whether the third bit from the last in the previous video/audio adjustment value is 1. An examination result of 0 indicates the adjustment is performed slowly. Further, in step S426, whether the first determination value is greater than the third determination value is examined. The first determination value is an upper limit for the video/audio adjustment value and its value is 11. The third determination value is a lower limit for the video/audio adjustment value. If the comparison result is negative in the step of comparing whether the first determination value is greater than the third determination value, then the process continues to step S422, where whether the second determination value is greater than the third determination value is examined. The second determination value is an upper limit for the video/audio adjustment value and its value is 7. The third determination value is a lower limit for the video/audio adjustment value. If the examination result is negative in the step of examining whether the second determination value is greater than the third determination value, then the process sets a third video/audio adjustment counter value and the video/audio adjustment value is set to zero in step S424. In addition, the adjusted third video/audio adjustment value is stored in step S426 as the video/audio adjustment value for the next time. The third video/audio adjustment counter value is hexadecimal 0x12a, which corresponds to the original video/audio synchronous speed.

If the examination result is positive in the step of examining whether the second determination value is greater than the third determination value, then a second video/audio adjustment counter value and a second video/audio adjustment value are added in step S428 and the adjusted second video/audio adjustment value is stored in step S430 as the video/audio adjustment value for the next time. The second video/audio adjustment counter value is hexadecimal 0x232, and the second video/audio adjustment value is hexadecimal 0x0007.

If the examination comparison result is positive in the step of examining whether the first determination value is greater than the third determination value, then a second video/audio adjustment counter value and a second video/audio adjustment value are added in step S428 and the adjusted second video/audio adjustment value is stored in step S430 as the video/audio adjustment value for the next time. The second video/audio adjustment counter value is hexadecimal 0x232, and the second video/audio adjustment value is hexadecimal 0x0007.

If the examination result shows a fast adjustment in the step of determining whether the video/audio adjustment is performed fast or slowly according to the previous video/audio adjustment value, it indicates that the optical disk is suffering a strong shock or is forced to cease operating and therefore a much greater video/audio adjustment value is obtained. In step S432, the system further obtains a third determination value from a first determination value. The first determination value is an upper limit for the video/audio adjustment value and its value is 11. The third determination value is a lower limit for the video/audio adjustment value. Subsequently, the fast adjustment degree of the previous video/audio adjustment value is determined in step S434 according to the third determination value. If the determination result is small in the step of determining the fast adjustment degree of the previous video/audio adjustment value according to the third determination value, then a first video/audio adjustment counter value and a first video/audio adjustment value are added in step S436 and the adjusted first video/audio adjustment value is stored in step S438 as the video/audio adjustment value for the next time. The first video/audio adjustment counter value is hexadecimal 0x14a, and the first video/audio adjustment value is hexadecimal 0x0003.

If the determination result is large in the step of determining the fast adjustment degree of the previous video/audio adjustment value according to the third determination value, then a second video/audio adjustment counter value and a second video/audio adjustment value are added in step S428 and the adjusted second video/audio adjustment value is stored in step S430 as the video/audio adjustment value for the next time. The second video/audio adjustment counter value is hexadecimal 0x232, and the second video/audio adjustment value is hexadecimal 0x0007.

By using the method for fast synchronization of video and audio playback of the invention, video and audio playback of a digital versatile disk in a DVD player are always synchronous in all circumstances. The present invention not only provides the fine-tuning function of the prior art, but also avoids the vibrations resulting from coarse tuning. According to the invention, the system counter value and the audio counter value can be tuned to approximate each other in a very short time, effectively resolving the problem of video/audio asynchronicity.

While the present invention has been described with reference to the detailed description and the drawings of the preferred examples thereof, it is to be understood that the invention should not be considered as limited thereby. Various modifications and changes could be conceived of by those skilled in the art without departuring from the scope of the present invention, which is indicated by the appended claims.

1. A method for fast synchronization of video and audio playback, comprising the steps of:
examining whether or not a video/audio signal is synchronous, said video/audio signal including a video signal and an audio signal;
if an examination result shows said video signal is smaller than said audio signal, performing a video signal speed-up mechanism;
if the examination result shows said video signal is greater than said audio signal, further executing steps as follows:
examining a previous video/audio adjustment value of said video/audio signal;
determining whether said previous video/audio adjustment value is greater than a first determination value;
determining whether said previous video/audio adjustment value is greater than a second determination value; and
adding a first video/audio adjustment counter value and a first video/audio adjustment value.

2. The method for fast synchronization of video and audio playback of claim 1, wherein each said first determination value and said second determination value is an upper limit for said video/audio adjustment value.

3. The method for fast synchronization of video and audio playback of claim 1, wherein if said previous video/audio adjustment flag value is smaller than said first determination value in said step of determining whether said previous video/audio adjustment flag value is greater than a first determination value, the method proceeds to a next step, whereas if said previous video/audio adjustment flag value is greater than said first determination value, the method further comprises the steps of:
adding a second video/audio adjustment counter value and a second video/audio adjustment value; and
storing said adjusted second video/audio adjustment value as a video/audio adjustment flag value for the next time.

4. The method for fast synchronization of video and audio playback of claim 1, wherein said step of adding a first video/audio adjustment counter value and a first video/audio adjustment value further comprises a step of storing said adjusted first video/audio adjustment value as a video/audio adjustment value for a next time.

5. A method for examining a previous video/audio adjustment value in fast synchronization of video and audio playback, comprising the steps of:
determining whether an video/audio adjustment is performed fast or slowly according to said previous video/audio adjustment value;
obtaining a third determination value from a first determination value;
determining a fast adjustment degree of said previous video/audio adjustment value according to said third determination value;
adding a first video/audio adjustment counter value and a first video/audio adjustment value; and
storing said adjusted first video/audio adjustment value as a video/audio adjustment value for a next time.

6. The method for examining a previous video/audio adjustment value in fast synchronization of video and audio playback of claim 5, wherein if a fast adjustment is determined in said step of determining whether the video/audio adjustment is performed fast or slowly according to said previous video/audio adjustment value, then the method proceeds to a next step, whereas if a slow adjustment is determined, the method further comprises the steps of:
determining whether a first determination value is greater than said third determination value;
determining whether a second determination value is greater than said third determination value;
setting a third video/audio adjustment counter value and setting said video/audio adjustment value to zero; and
storing said adjusted third video/audio adjustment value as a video/audio adjustment value for the next time.

7. The method for examining a previous video/audio adjustment value in fast synchronization of video and audio playback of claim 6, wherein each of said first determination value and said second determination value is an upper limit for said video/audio adjustment value.

8. The method for examining a previous video/audio adjustment value in fast synchronization of video and audio playback of claim 6, wherein said third determination value is a lower limit for said video/audio adjustment value.

9. The method for examining a previous video/audio adjustment value in fast synchronization of video and audio playback of claim 6, wherein if a determination result is negative in said step of determining whether said first determination value is greater than said third determination value, then the method proceeds to a next step, whereas if the determination result is positive, the method further comprises the steps of:
adding a second video/audio adjustment counter value and a second video/audio adjustment value; and
storing said adjusted second video/audio adjustment value as a video/audio adjustment value for the next time.

10. The method for examining a previous video/audio adjustment value in fast synchronization of video and audio playback of claim 6, wherein if the determination result is negative in said step of determining whether said second determination value is greater than said third determination value, then the method proceeds to the next step, whereas if the determination result is positive, the method further comprises the steps of:
adding a second video/audio adjustment counter value and a second video/audio adjustment value; and
storing said adjusted second video/audio adjustment value as a video/audio adjustment value for the next time.

11. The method for examining a previous video/audio adjustment value in fast synchronization of video and audio playback of claim 5, wherein if determination result is small in said step of determining a fast adjustment degree of said previous video/audio adjustment value according to said third determination value, then the method proceeds to the next step, whereas if the determination result is large, the method further comprises the steps of:
adding a second video/audio adjustment counter value and a second video/audio adjustment value; and
storing said adjusted second video/audio adjustment value as a video/audio adjustment value for the next time.

12. A method for fast synchronization of video and audio playback, comprising the steps of:
examining whether or not a video/audio signal is synchronous;
examining whether or not a previous video/audio adjustment value of said video/audio signal is adjusted;
determining whether said previous video/audio adjustment value is greater than a first determination value;
determining whether said previous video/audio adjustment value is greater than a second determination value;
adding a first video/audio adjustment counter value and a first video/audio adjustment value; and
storing said adjusted first video/audio adjustment value as a video/audio adjustment value for a next time.

13. The method for fast synchronization of video and audio playback of claim 12, wherein said video/audio signal includes a video signal and an audio signal.

14. The method for fast synchronization of video and audio playback of claim 13, wherein if an examination result shows said video signal is greater than the audio signal in said step of examining whether or not said video/audio signal is synchronous, then the method proceeds to a next step, whereas if the examination result shows that the video signal is smaller than the audio signal, the method further comprises a step of a video signal speed-up mechanism.

15. The method for fast synchronization of video and audio playback of claim 12, wherein if an examination result is negative in said step of examining a previous video/audio adjustment value of said video/audio signal, then the method proceeds to the next step, whereas if the examination result is positive, the method further comprises the steps of:
determining whether the video/audio adjustment is performed fast or slowly according to said previous video/audio adjustment value;
obtaining a third determination value from a first determination value;
determining a fast adjustment degree of said previous video/audio adjustment value according to said third determination value;
adding a first video/audio adjustment counter value and a first video/audio adjustment value; and
storing said adjusted first video/audio adjustment value as a video/audio adjustment value for the next time.

16. The method for fast synchronization of video and audio playback of claim 15, wherein if the examination result shows a fast adjustment in said step of determining whether the video/audio adjustment is performed fast or slowly according to said previous video/audio adjustment value, then the method proceeds to the next step, whereas if the examination result shows a slow adjustment, the method further comprises the steps of:
comparing whether said first determination value is greater than said third determination value;
comparing whether said second determination value is greater than said third determination value;
setting a third video/audio adjustment counter value and setting said video/audio adjustment value to zero; and
storing said adjusted third video/audio adjustment value as a video/audio adjustment value for the next time.

17. The method for fast synchronization of video and audio playback of claim 16, wherein each of said first determination value and said second determination value is an upper limit for said video/audio adjustment value.

18. The method for fast synchronization of video and audio playback of claim 16, wherein said third determination value is a lower limit for said video/audio adjustment value.

19. The method for fast synchronization of video and audio playback of claim 16, wherein if the determination result is negative in said step of determining whether said first determination value is greater than said third determination value, then the method proceeds to the next step, whereas if the determination result is positive, the method further comprises the steps of:
adding a second video/audio adjustment counter value and a second video/audio adjustment value; and
storing said adjusted second video/audio adjustment value as a video/audio adjustment value for the next time.

20. The method for fast synchronization of video and audio playback of claim 16, wherein if the comparison result is negative in said step of determining whether said second determination value is greater than said third determination value, then the method proceeds to the next step, whereas if the determination result is positive, the method further comprises the steps of:
adding a second video/audio adjustment counter value and a second video/audio adjustment value; and
storing said adjusted second video/audio adjustment value as a video/audio adjustment value for the next time.

21. The method for fast synchronization of video and audio playback of claim 15, wherein if the determination result is small in said step of determining a fast adjustment degree of said previous video/audio adjustment value according to said third determination value, then the method proceeds to the next step, whereas if the determination result is large, the method further comprises the steps of:
adding a second video/audio adjustment counter value and a second video/audio adjustment value; and
storing said adjusted second video/audio adjustment value as a video/audio adjustment value for the next time.
